(19) United States
(12) Patent Application Publication
(10) Pub. No.: US 2003/0054207 A1
(43) Pub. Date: Mar. 20, 2003

(54) Metal oxide films

(76) Inventors: John C. Warner, Quincy, MA (US); Alessandra Morelli, Edinburgh (GB)

Correspondence Address: FISH & RICHARDSON PC, 225 FRANKLIN ST, BOSTON, MA, 02110, US

(21) Appl. No.: 10/198,611

(22) Filed: Jul. 17, 2002

Related U.S. Application Data
(60) Provisional application No. 60/306,213, filed on Jul. 18, 2001.

(51) Int. Cl. B32B 15/04

(52) U.S. Cl. 428/702

(57) ABSTRACT

The invention relates to colloidal films of metal oxide particles and organic acids, wherein the organic acid contains at least two carboxylic acid groups. These films can be used in many applications, including light-emitting devices and photovoltaic cells. When added to the metal oxide particles, the organic acids provide good mechanical strength and prevent the colloidal films from delaminating and flaking, while simultaneously avoiding the need for high temperature sintering.

### CROSS-REFERENCE TO RELATED APPLICATION

This application claims priority from U.S. Provisional Patent Application Serial No. 60/306,213, filed on Jul. 18, 2001, which is incorporated herein by reference in its entirety.

### TECHNICAL FIELD

This invention relates to metal oxide films.

### BACKGROUND

Thin film coatings of metal oxide particles are used in many applications including photo-energy conversion devices, light emitting devices, and solid phase catalytic processes. These metal oxide particles are processed to provide mechanical strength and prevent the metal oxide materials from delaminating or separating from the solid onto which they were applied. The processing of these materials often requires using harsh conditions, including high temperatures. The high temperatures can increase manufacturing costs and limit the range of starting materials that can be used.

### SUMMARY

The invention is based on the discovery that the properties of metal oxide colloidal films can be significantly improved by the addition of small organic acids. Thin film coatings of metal oxide particles are used in many applications, including light emitting devices and photovoltaic cells. However, when metal oxide films are coated onto a solid support, the film coatings are typically not robust, and the films can begin to deteriorate by delamination and fracturing after a short period of time. The addition of small organic acids to metal oxide films provides good mechanical strength and prevents the delamination of metal oxide particles when forming thin colloidal films, while simultaneously reducing or avoiding the need for high temperature sintering.

In general, the invention features a colloidal film including metal oxide particles and an organic acid, where the organic acid contains at least two carboxylic acid groups. For example, the metal oxide particles can be, but are not limited to, TiO₂, SiO₂, or Al₂O₃ particles. The organic acids can have a molecular weight between 100 and 550 grams/mol, e.g., between 150 and 425 grams/mol, or between 200 and 300 grams/mol. Examples of useful organic acids include, but are not limited to, trimesic acid and terephthalic acid.

The organic acids comprise about 1%-9% by weight of the metal oxide particles, e.g., about 2%-7% by weight of the metal oxide particles, or about 3%-5% by weight of the metal oxide particles.

The invention also features a method of making a metal oxide colloidal film. The method includes combining metal oxide particles, e.g., TiO₂, SiO₂, or Al₂O₃ particles, with a small organic acid having at least two carboxylic acid groups, to form a mixture. The mixture is then applied to a solid support, forming a thin film coating on the support. Finally, the coated solid support is exposed to conditions that allow the film to set. The solid support can be made of, for example, glass, plastic, textile or fabric, quartz, ceramic, silica, or metal, and can be rigid or flexible. The setting conditions include a temperature of less than about 450, 400, 300, 200, 150, or 100° C. The setting temperature can be about 80 or 100° C.

In another embodiment, the invention features a device including a colloidal film, wherein the film includes metal oxide particles and an organic acid. Additionally, a substrate can be electrically connected to the film. In various embodiments, the device can be a light emitting device or a component thereof, a film-based catalyst system, a system for water or air purification, a photo-energy conversion device, a stencil, or a mask.

In another embodiment, the invention can be a coating, e.g., a paint, including a colloid of metal oxide particles and organic acids that each contains at least two carboxylic acid groups.

The invention also features a colloidal film made by the process of combining metal oxide particles with a small organic acid having at least two carboxylic acid groups, and forming a mixture. The mixture is applied to a solid support, forming a thin film coating on the support; and conditions are applied that allow the film to set.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and are not intended to be limiting.

The invention improves the physical properties of thin metal oxide colloidal films. These improved physical properties allow the colloidal films to “set” at about room temperature, which avoids the necessity for use of high temperatures, e.g., greater than 400° C., during processing of the films. As a result, the invention provides an improved manufacturing process for metal oxide films and a greater flexibility in useful starting materials, all without sacrificing the quality of the films.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWING

FIG. 1 is a graph demonstrating the improvement in adhesion properties as the percentage of trimesic acid is increased from 0% to 5% by weight of suspended TiO₂.

### DETAILED DESCRIPTION

The invention is based on the discovery that small organic acids can be used to provide good mechanical strength and to prevent delamination (i.e., by increasing the adhesion) of metal oxide particles when forming thin colloidal films. Without the addition of a small organic acid to a film of metal oxide particles, the film delaminates and flakes away from the solid support on which it was deposited. Traditional methods of forming colloidal films made of metal oxide particles require a sintering step at a temperature of at least about 400 to 450° C. after the film is deposited onto the solid support, to “set” the film. Not only does this step require a large amount of energy, but it also limits the variety of starting materials that can be used in the manufacturing process.

The metal oxide films described herein have improved physical properties, including decreased solubility. These improved solubility properties allow the resulting film to “set” at about room temperature, without the need for a sintering step at 400° or more, e.g., 450° C., which results in a more versatile and reproducible process for producing the desired thin coatings of metal oxide particles.

In one embodiment, the film is a colloid having metal oxide particles combined with an organic acid. The metal oxide particles can be, e.g., TiO₂, SiO₂, or Al₂O₃. The organic acid has at least two carboxylic acid groups per molecule. Examples of organic acids include those having a molecular weight ranging from about 100 to 550 grams/mol, e.g., from 150 to 425 grams/mol, or 200 to 300 grams/mol. In some embodiments, trimesic acid or terephthalic acid is used as the organic acid. The amount of the small organic acid ranges from about 1% to 9% by weight of metal oxide particles, e.g. from about 1% or 2% to 7% by weight of metal oxide particles, or from about 3% to 5% by weight of metal oxide particles.

These new colloidal films can be made by combining the metal oxide particles with the small organic acid to form a mixture. The metal oxide particles can either be processed directly or formed through hydrolysis of more stable precursors using a mineral acid. The mixture is then applied or deposited onto a solid support to form a thin film coating on the solid support. Examples of solid supports include glass, plastic, fabric, quartz, ceramic, silica, and metal. The support can be rigid or flexible. The film-coated solid support is then exposed to conditions that allow the film to set. Because temperatures above 400° C. are not required in the new methods, a wide variety of supports can be used.

As noted, the first step in the preparation of the metal oxide film can include a hydrolysis and polymerization step using a mineral acid to prepare the metal oxide particles. Standard procedures for this preparation are known in the art. While HNO₃ is commonly used in this preparation step, other useful mineral acids include H₂SO₄, H₃PO₄, HCl, and HBr.

In recent years, applications for thin metal oxide films have grown at a rapid pace. These films are used in devices ranging from flat computer screens to photo-energy conversion devices. However, films of metal oxide particles alone have poor physical properties and therefore cannot readily be used in the many applications in which they are needed. While there are some modifications available to improve the properties of the metal oxide films, the present invention improves the physical properties of the metal oxide films in a manner that leads not only to a more robust film, but also allows more flexibility in the manufacture of the films.

Thus, the invention includes various devices having components made of or coated by the new colloid films, as well as devices that are coated with the new films. Examples of such devices include photo-energy conversion devices (photovoltaic cells), stencils, masks, light-emitting devices, flat screen devices, solid film-based catalytic systems, and water purification systems. Once the new coatings are prepared, they can be easily applied to a variety of devices using known methods.

For example, the new films can be used in the preparation of photovoltaic cells having one or more flexible substrates that can be manufactured at relatively low temperatures in a continuous process, such as a roll-by-roll or sheet-by-sheet process. Flexible photovoltaic cells can be used, for example, in canopies for defense, commercial, residential, and agricultural applications, or in fabrics, e.g., used for clothing.

In addition, the new films and coatings can be used in photocatalysts used to remove pollutants from air and water, for deodorizing air, and for other cleaning and sterilizing applications. See, e.g., U.S. Patent Nos. 5,919,422 and 6,387,844. The coatings can also be used to create photocatalytically-activated self-cleaning surfaces for structures, buildings, and devices. These films can be used to remove organic contaminants from the surface by exposing the device to irradiation at the proper wavelength. See, e.g., U.S. Pat. No. 6,054,227. In buildings, the new films can be applied to external or internal wall, ceiling, flooring, and roofing materials, such as glass, tile, concrete, stone, metal, and the like, to provide deodorizing, anti-mold, anti-microbial, anti-soiling, and ultraviolet-ray absorbing characteristics to the building material. See, e.g., U.S. Pat. No. 5,643,436. The new films can also be used in dichroic mirrors, and in capacitors, e.g., in integrated circuits. See, e.g., U.S. Pat. No. 6,214,660.

The invention also includes paints and coatings made from colloids having metal oxide particles combined with small organic acids. These paints can provide anti-microbial, deodorizing, self-cleaning, and other characteristics to various building materials as noted above. See, e.g., U.S. Pat. No. 5,795,251.

### EXAMPLES

The invention is further described in the following examples, which do not limit the scope of the invention described in the claims.

### Example 1

Titanium IV isopropoxide was hydrolyzed into titanium dioxide by filling a beaker of 150 mls of deionized water and adding 1.05 mls of 70% HNO₃. Twenty-five mls of titanium IV isopropoxide was then added drop by drop while limiting its exposure to air over a ten-minute span. The solution of water and nitric acid was stirred vigorously as the titanium IV isopropoxide was added. The solution was heated to 80° C. while still stirring, for 8 to 12 hours, until the volume was reduced to 50 mls.

The resulting suspension was separated into five vials of 10 mls each. Increasing amounts of trimesic acid were added to four vials as follows: 1.75%, 2.5%, 3.75%, and 5% by weight of suspended TiO₂. The fifth vial contained no trimesic acid. The solutions were heated in sealed tubes at 180° C. to 200° C. for 12 hours in an oil bath. Each solution was then cooled to room temperature, removed from the sealed tube, and stored in a separate vial.

Each of five glass slides of known weight were coated with one of the five solutions, observed, allowed to “set” at 80° C. for 4 to 5 hours, and then weighed. The slides were shaken and washed with ethanol to remove all the particles of the coating that were not permanently adhered to the slides. The slides were then dried, observed, and the weight of the coatings that remained on the slides was quantified.

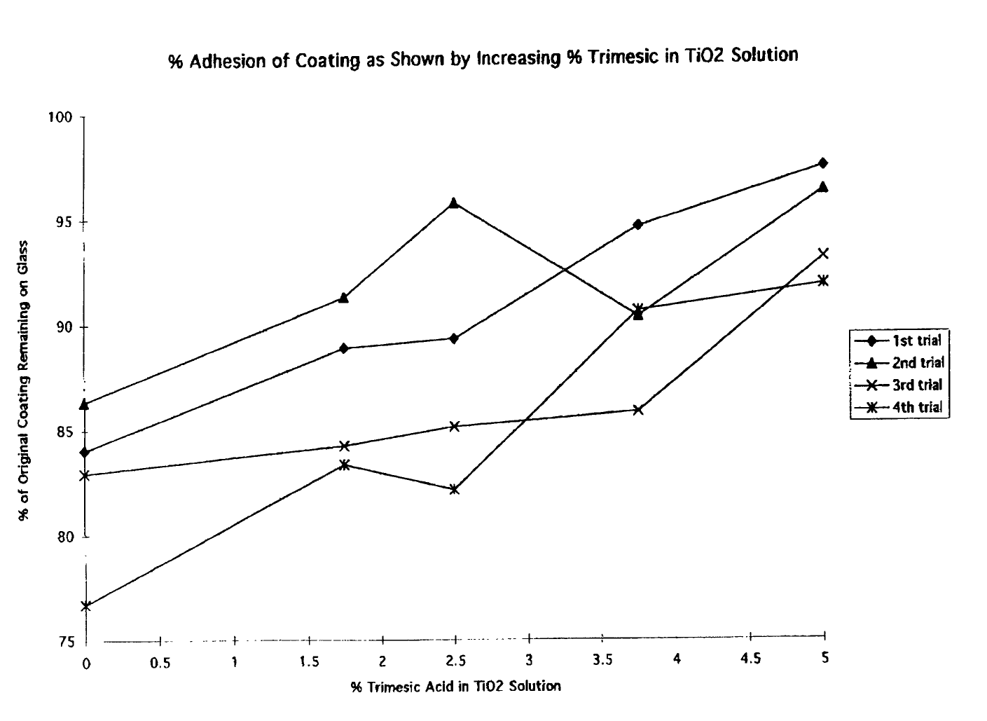

The experiment was repeated four times (trials 1 through 4). The percent adherence of the original four coatings was determined for all the solutions and the results are displayed in FIG. 1, which shows four lines, each representing one trial with the four different concentrations of trimesic acid. All four trials showed a general increase in the percentage of original coating remaining on the glass substrate with increasing percentage of organic acid. Coatings of TiO₂ alone (without trimesic acid) visually appear cracked and of varying thickness. In addition, these control coatings delaminated and “flaked” off the glass.

Although the present invention provides a method of producing metal oxide films that do not require certain processes and materials commonly used in the art, the results demonstrate the utility of the method as compared to metal oxide films made using prior methods. For example, the new method does not require the use of surfactants/polymers, such as carbowax, used in prior methods to increase the integrity of colloidal films. Instead, use of the new methods to form metal oxide films result in a product having comparable strength and adhesion to films made with the addition of surfactants/polymers.

### Example 2

25 ml of titanium IV isopropoxide was added dropwise to 150 ml of a solution of HNO₃ 0.109 M. The solution was stirred at 80° C. for 10 hours, letting the water evaporate to 50 ml, bringing the final concentration of TiO₂ to between 100 and 150 g/L. A 10 ml aliquot of the solution was treated by adding 0.015 g trimesic acid (1% by weight of TiO₂). The solution was warmed to 200° C. for 12 hours. The solution was cooled to room temperature and then vigorously stirred for 15 minutes. The solution was coated onto a glass slide, dried in a hot air stream, and then warmed to 80° C. in an oven for 4 to 5 hours, allowing the film to set. The coating remained optically transparent and did not delaminate from the support.

### Example 3

25 ml titanium IV isopropoxide was added dropwise to 150 ml of a solution of HNO₃ 0.109 M. The solution was stirred at 80° C. for 10 hours, letting the water evaporate to 50 ml, bringing the final concentration of TiO₂ to between 100 and 150 g/L. A 10 ml aliquot of the solution was treated by adding 0.075 g trimesic acid (5% by weight of TiO₂). The solution was warmed to 200° C. for 12 hours. The solution was cooled to room temperature and then vigorously stirred for 15 minutes. The solution was coated onto a glass slide, dried in a hot air stream, and then warmed to 80° C. in an oven for 4 to 5 hours, allowing the film to set. The coating remained optically transparent and did not delaminate from the support.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A colloidal film comprising metal oxide particles and an organic acid wherein the organic acid contains at least two carboxylic acid groups.

2. The film of claim 1, wherein the metal oxide particles are TiO₂, SiO₂, or Al₂O₃ particles.

3. The film of claim 1, wherein the metal oxide particles are TiO₂ particles.

4. The film of claim 1, wherein the organic acid has a molecular weight between 100 and 550 grams/mol.

5. The film of claim 1, wherein the organic acid has a molecular weight between 150 and 425 grams/mol.

6. The film of claim 1, wherein the organic acid has a molecular weight between 200 and 300 grams/mol.

7. The film of claim 1, wherein the organic acid is trimesic acid.

8. The film of claim 1, wherein the organic acid comprises about 1%-9% by weight of the metal oxide particles.

9. The film of claim 1, wherein the organic acid comprises about 2%-7% by weight of the metal oxide particles.

10. The film of claim 1, wherein the organic acid comprises about 3%-5% by weight of the metal oxide particles.

11. A method of making a colloidal film, the method comprising;
(a) combining metal oxide particles with an organic acid, wherein the organic acid contains at least two carboxylic acid groups, to form a mixture;
(b) depositing the mixture onto a solid support to form a thin coating on the solid support; and
(c) applying conditions that allow the thin coating to set.

12. The method of claim 11, wherein the metal oxide particles are TiO₂, SiO₂, or Al₂O₃ particles.

13. The method of claim 11, wherein the metal oxide particles are TiO₂ particles.

14. The method of claim 11, wherein the organic acid has a molecular weight between 100 and 550 grams/mol.

15. The method of claim 11, wherein the organic acid has a molecular weight between 150 and 425 grams/mol.

16. The method of claim 11, wherein the organic acid has a molecular weight between 200 and 300 grams/mol.

17. The method of claim 11, wherein the organic acid comprises about 1%-9% by weight of the metal oxide particles.

18. The method of claim 11, wherein the organic acid comprises about 2%-7% by weight of the metal oxide particles.

19. The method of claim 11, wherein the organic acid comprises about 3%-5% by weight of the metal oxide particles.

20. The method of claim 11, wherein the solid support is glass, plastic, fabric, quartz, ceramic, silica, or metal.

21. The method of claim 11, wherein the solid support is rigid.

22. The method of claim 11, wherein the solid support is flexible.

23. The method of claim 11, wherein the conditions that allow the thin coating to set include a temperature less than about 400° C.

24. The method of claim 11, wherein the conditions that allow the thin coating to set include a temperature less than about 200° C.

25. The method of claim 11, wherein the conditions that allow the thin coating to set include a temperature less than about 100° C.

26. The method of claim 11, wherein the conditions that allow the thin coating to set include a temperature of about 80° C.

27. A device comprising;
(a) the film of claim 1; and
(b) a substrate electrically connected to the film.

28. The device of claim 27, wherein the device is a component of a light-emitting device.

29. The device of claim 27, wherein the device is a photo-energy conversion device.

30. A device comprising the film of claim 1 on a surface of the device.

31. The device of claim 30, wherein the device is a component of a catalyst system.

32. The device of claim 31, wherein the device is a catalyst system used for water purification.

33. The device of claim 30, wherein the device is a building material.

34. The device of claim 30, wherein the device is a stencil or mask.

35. A coating comprising a colloidal film of claim 1.

36. The coating of claim 35, wherein the coating is a paint.

37. A colloidal film made by the process of claim 11.
